(19) United States
(12) Patent Application Publication
(10) Pub. No.: US 2015/0168313 A1
(43) Pub. Date: Jun. 18, 2015

(54) SYSTEM AND METHOD FOR PERMITTIVITY DISTRIBUTIONS WITH TRANSIT TIME AND DISPERSION TOMOGRAPHY

(71) Applicant: BAYLOR UNIVERSITY, Waco, TX (US)

(72) Inventor: Buford Randall Jean, Lorena, TX (US)

(73) Assignee: BAYLOR UNIVERSITY, Waco, TX (US)

(21) Appl. No.: 14/401,728

(22) PCT Filed: May 20, 2013
(86) PCT No.: PCT/US2013/041847

§ 371 Date: Nov. 17, 2014

Related U.S. Application Data
(60) Provisional application No. 61/650,186, filed on May 22, 2012.

(51) Int. Cl. G01N 22/00

(52) U.S. Cl. CPC G01N 22/00

(57) ABSTRACT

The disclosure provides an electromagnetic (EM) sensor system and method that permits rapid and non-invasive measurement of material properties using measurements of the dispersion of EM energy signals over a wide band of frequencies, including second and higher order moments. The EM energy can be a pulse signal, including an ultra-wide band (“UWB”) pulse signal. A plurality of signals can be incrementally projected through the material in a grid. The grid can generally include a series of projections through the material of an object at different angles. The further analysis of the dispersion characteristics of the EM energy signal provides a measure of added features that assist in improved characterization of the material properties. In at least one embodiment, the results of processed pulses through the object can be used to form a two-dimensional or three-dimensional image of the material for the particular property being measured.

### CROSS REFERENCE TO RELATED APPLICATIONS

The present invention is a 35 U.S.C. 371 application of PCT/US2013/041847 filed May 20, 2013 claims priority to U.S. Provisional Application Ser. No. 61/650,186, filed May 22, 2012, entitled “System And Method For Permittivity Distributions With Transit Time And Dispersion Tomography””, the contents of all of which are incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure relates generally to a system and method for measurement of material properties through complex permittivity distributions of wide band electromagnetic energy. More specifically, the disclosure relates to a system and method for non-contact measurement of material properties with dispersion through materials of short pulses with wide band frequencies.

2. Description of the Related Art

Electromagnetic (“EM”) properties of most real world materials are frequency dependent. Information about the composition of the substance can be obtained by exposing the substance to EM energy at different frequencies and analyzing the response at each frequency. The term “permittivity” is used to describe how an electric field affects and is affected by a material having dielectric properties, that is, permittivity relates to a material's ability to transmit (or “permit”) an electric field. Permittivity is determined by the ability of a material to polarize in response to an externally applied field and reduce the total electric field inside the material. Permittivity includes complex electrical permittivity and the magnetic permeability. Permittivity is often expressed as a relative permittivity ∈ᵣ to the permittivity ∈₀ of a vacuum. The response of real world materials to external EM fields normally depends on the frequency of the field, because the material's polarization does not respond instantaneously to an applied field. Permittivity for materials can be expressed as a complex function to allow specification of magnitude and phase of the permittivity as a function of the angular frequency (w) of the applied field with real and imaginary components as follows:

∈ᵣ(ω)=∈ᵣ′(ω)−j∈ᵣ″(ω)

Magnetic permeability, as another form of a material's response to applied EM energy, can be compared with electrical permittivity in that it is the degree of magnetization of material from reordered magnetic dipoles in the material when responding to a magnetic field applied to the material. Magnetic permeability is often expressed as a relative permeability to permeability in a vacuum. Magnetic permeability is also frequency dependent for real world materials and can include real and imaginary components.

For example, PCT Publ. No. WO 2011/100390, Jean, describes an electromagnetic (EM) sensor system and method that permits rapid and non-invasive measurement of blood glucose or other biological characteristics that exhibits a unique spectral signature, such as its complex electrical permittivity within the frequency range from near DC to microwave frequencies. Low-level EM signals are coupled through the skin and modified by electrical properties of the sub dermal tissues. These tissues essentially integrate with the sensor circuit as they interact with the transmitted EM energy. The guided-wave signal can be sampled and converted to a digital representation. The digital information can be processed and analyzed to determine the frequency-sensitive permittivity of the tissues and a determination of blood glucose level is made based upon the sensor output. The sensor design and method has wide-ranging applicability to a number of important measurement problems in industry, biology, medicine, and chemistry, among others.

Tomography provides non-invasive imaging of object interiors and has current applications in medical diagnosis, construction, and manufacturing. Examples of tomography include magnetic resonance (MRI) tomographic images, computed axial tomography (CAT) scans, electrical impedance tomography, and positron emission tomography (PET) which use different imaging techniques. For transit time tomography, the underlying concept is that measurement of transit times of EM waves through an object in all directions allows reconstruction of the object's interior

Some recent advances of imaging include using wide band pulses, or other wide band modulation waveforms, at microwave frequencies. In at least one experiment, researchers made a two-dimensional image in an X-Y axis plane by transmitting wide band stepped frequency waveforms through the material to a receiver in incremental locations in a series of parallel line projections, rotating the object by an incremental angle, and then transmitting another series of excitations in incremental locations, to form a 2-D grid of properties based on the group delay of the waveform. The researchers used a Radon transform parallel projection process to analyze the data, based on the time differential of a signal's group velocity through the material from the multiple angles of parallel lines. The collection time of data for one image was reported to be 40 hours. While others have used time-of-flight measurements for measuring permittivity, time-of-flight alone does not provide a determination of specific properties for various materials.

Despite the advances in tomography and knowledge of such processing, the imagery is nominal, time consuming, expensive, and has not provided a level of detail needed for substantial material property identification and imaging.

There remains a need for an improved system and method for non-invasive analysis using new and potentially more accurate techniques to more appropriately identify material properties through EM energy responses.

### BRIEF SUMMARY OF THE INVENTION

The disclosure provides an electromagnetic (EM) sensor system and method that permits rapid and non-invasive measurement of material properties using measurements of the dispersion of EM energy signals over a wide band of frequencies, including second and higher order moments. The EM energy can be a pulse signal, including an ultra-wide band (“UWB”) pulse signal. A plurality of signals can be incrementally projected through the material in a grid. The grid can generally include a series of projections through the material of an object at different angles. The further analysis of the dispersion characteristics of the EM energy signal provides a measure of added features that assist in improved characterization of the material properties. In at least one embodiment, the results of processed pulses through the object can be used to form a two-dimensional or three-dimensional image of the material for the particular property being measured.

The disclosure provides an improvement for EM pulse signal processing by considering additional information on the EM energy that is instead of or in addition to the velocity of the centroid (center of mass) of the EM energy as the “group velocity” of the EM energy. By examining the dispersion of the EM energy and producing an image of the object based on the dispersion of the EM energy, different information becomes apparent to the reader of the output that has not been available using the group velocity of the EM energy in prior efforts.

The use of dispersive proprieties of the object materials for imaging has applicability to a broad range of uses. Such applications could range from remote non-invasive and/or non-contact sensing of any number of material properties, including and not limited to, food properties, such as calorie counting; protein content, moisture content, and fat content, medical analysis, such as greater resolution of tissue abnormalities and the composition of the abnormalities such as benign or cancerous without necessitating biopsies, predictive analysis of diseases based on material compositions and proclivities perhaps over a time period without invasive surgery, industrial and construction materials, such as quality or purity of sand and concrete, and any other properties that can be identified based on the response to such EM energy.

### BRIEF DESCRIPTION OF THE SEVERAL VIEWS OF THE DRAWINGS

FIG. 1A is an ideal representation of a EM pulse at an initial time T0 at a location A and the pulse traveling through a vacuum to a location B for a given transit time T1.

FIG. 1B is an ideal representation of the same EM pulse at an initial time T0 at location A and the pulse traveling through a material with permittivity to the location B for a different transit time T2.

FIG. 2 is a graphical representation of an exemplary ultra-wide band pulse signal.

FIG. 3 is the frequency domain representation of the pulse in FIG. 2.

FIG. 4 is a representation of an EM UWB pulse at an initial time T0 at location A and the pulse traveling through the same material of FIG. 1B to location B for a given time T2.

FIG. 5A is a representation of a single UWB pulse passing through a material from location A to location B in an X-Y orthogonal plane.

FIG. 5B is a representation of a series of pulses passing through the material in stepped parallel line protections in an X-Y plane.

FIG. 5C is a representation of a series of pulses passing through the material in stepped parallel line protections in an X-Y-Z space. FIG. 6 is a block diagram of an exemplary embodiment of a sensor system.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The disclosure provides an electromagnetic (EM) sensor system and method that permits rapid and non-invasive measurement of material properties using measurements of the dispersion of EM energy signals over a wide band of frequencies, including second and higher order moments. The EM energy can be a pulse signal, including an ultra-wide band (“UWB”) pulse signal. A plurality of signals can be incrementally projected through the material in a grid. The grid can generally include a series of projections through the material of an object at different angles. The further analysis of the dispersion characteristics of the EM energy signal provides a measure of added features that assist in improved characterization of the material properties. In at least one embodiment, the results of processed pulses through the object can be used to form a two-dimensional or three-dimensional image of the material for the particular property being measured.

### Underlying Technology Explanation

The invention can use transit time tomography with any suitable EM energy waveform over a wide band of frequencies through an object having a material that is dispersive in nature. The wide band of frequencies can be used to image an object in terms of its permittivity density. In some embodiments, the EM energy can be a wide band pulse or an ultra-wideband (UWB) pulse or a series of stepped frequencies. Further, a number of modulation schemes are possible, such as pseudorandom sequence modulation. High permittivity along the signal's transmission path produces a longer delay in transit time than does low permittivity. An image created by the transit time tomography method can reveal non-homogeneous distribution characteristics of the material under test. The dispersion properties of the wide band, coupled with time delay measurement, can provide the needed information for material properties. Dispersion of the signal energy is caused by the differential velocity profile as a function of frequency along the transmission path as well as a differential attenuation profile versus frequency. While the description below discusses a UWB pulse as exemplary and nonlimiting embodiments, it is understood that other forms of EM energy can be used to generate the information used for the imaging and other properties and output described herein.

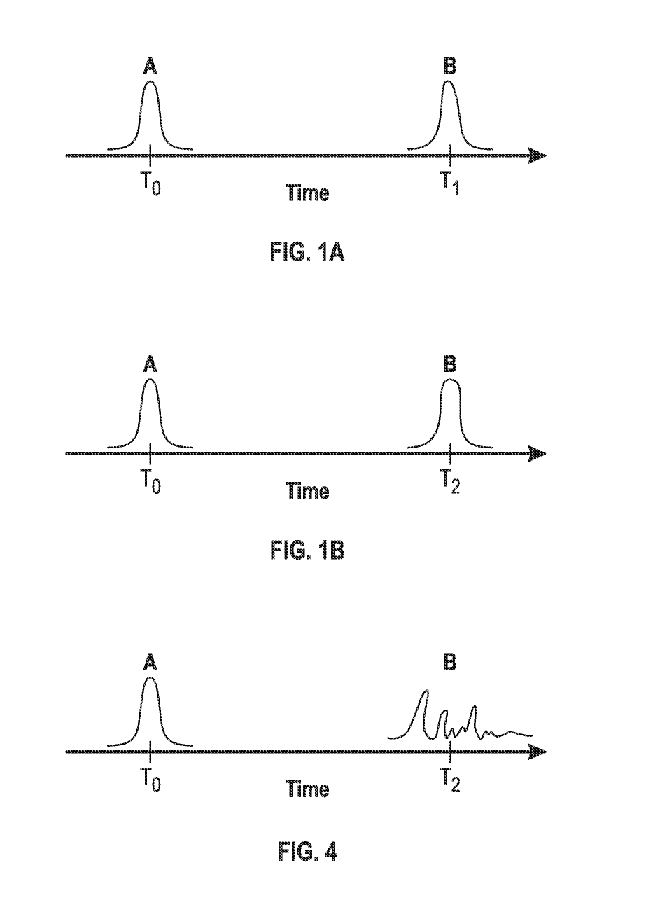

FIG. 1A is an ideal representation of a EM pulse at an initial time T0 at a location A and the pulse traveling through a vacuum to a location B for a given transit time T1. FIG. 1B is an ideal representation of the same EM pulse at an initial time T0 at location A and the pulse traveling through a material with permittivity to the location B for a different transit time T2. The real and imaginary components of permittivity of the given material or portion thereof constitute the material permittivity, and sometimes expressed as a related term of dielectric values. The inventor has used the change in transit times of the pulse through the material to produce a value of a material property based on such a change. With a sufficient number of values from a sufficient number of pulses through the material, a one-dimensional (1-D) representation of the material can be generated. With a sufficient number of values from a sufficient number of pulses through the material at multiple angles, a two-dimensional (2-D) representation of the material can be generated. However, the transit time alone may be insufficient to characterize accurately the material.

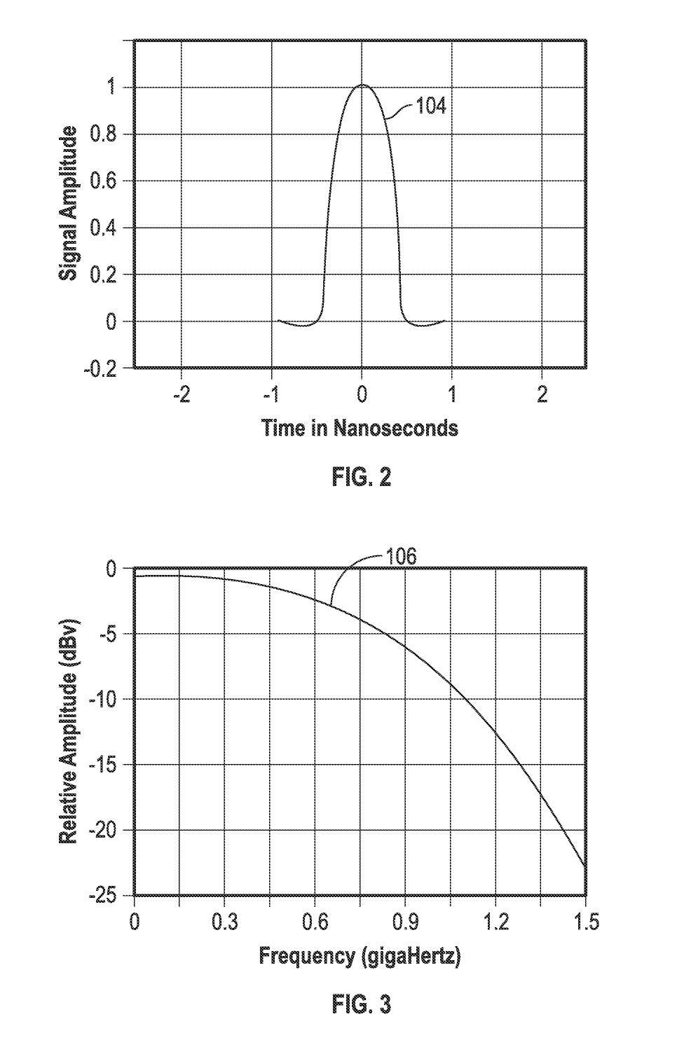

FIG. 2 is a graphical representation of an exemplary ultra-wide band pulse signal. FIG. 3 is the frequency domain representation of the pulse in FIG. 2. The figures will be described in conjunction with each other. The particular pulse shown in FIG. 1 is a Gaussian amplitude-weighted sin(x) over x pulse, representative of a general class of UWB pulses, but not the only type of pulse that can be used in the present invention. Other EM pulses, including non-UWB pulses can be used such as wideband pulses. (Note that in FIG. 2, both negative and positive values appear along the horizontal axes as shown, with time t=0 coinciding with the peak of the pulse. This is consistent with standard mathematical analysis methods, although other coordinate orientations can be employed.) An inverse relationship exists between the time duration of a pulse of energy and the frequency bandwidth of the energy spectrum of the pulse. The shorter the duration of the pulse, the wider will be the band of frequencies of energy comprising the pulse. Therefore, the frequency spectrum of a narrow input pulse, such as is shown in FIG. 2, will resemble the broad spectrum shown in FIG. 3. A sufficiently narrow UWB pulse 104 will exhibit a broad frequency domain 106 of energy that interacts over a desired frequency range with the material being examined. This broadband energy distribution interacts with, and is dispersed by, the material. This dispersion can be a function of frequency, the shape and size of the dispersive medium, and the characteristics of the material.

FIG. 4 is a representation of an EM UWB pulse at an initial time T0 at location A and the pulse traveling through the same material of FIG. 1B to location B for a given time T2. The UWB pulse disperses, because the UWB pulse has a continuum of a frequency distribution, and different frequencies of a given UWB pulse travel at different transit times through the material. For example, water is known to have a variable dielectric constants (and the associated variable permittivity) dependent on the frequency in question. A lower frequency passes through the water at a different transit time due to a dielectric value at that frequency than a higher frequency due to a different dielectric value at the higher frequency.

Thus, the dispersion of the frequencies of the UWB pulse is indicative of material properties. The dispersion of the UWB pulse creates essentially a “signature” of the material property. The dispersion of the UWB pulse can be correlated to different properties of a given material and further to different materials. The correlation can be by experimentally created databases, theoretical algorithms, or any other method of correlating the dispersive results of a pulse through the medium in questions.

Further, the dispersion of the pulse can be analyzed in multiple ways. Integrals and derivatives can be determined from the raw dispersion values that provide various other aspects of the material. The dispersion data can be referred to a as a second order moment. Third, fourth, and other higher order moments can be calculated and correlated to properties of the material.

The above description can be used as the basis for application to various embodiments, some of which are explained below.

### Application of Technology

For imagery, it is often useful to display features as a 2-D or 3-D representation.

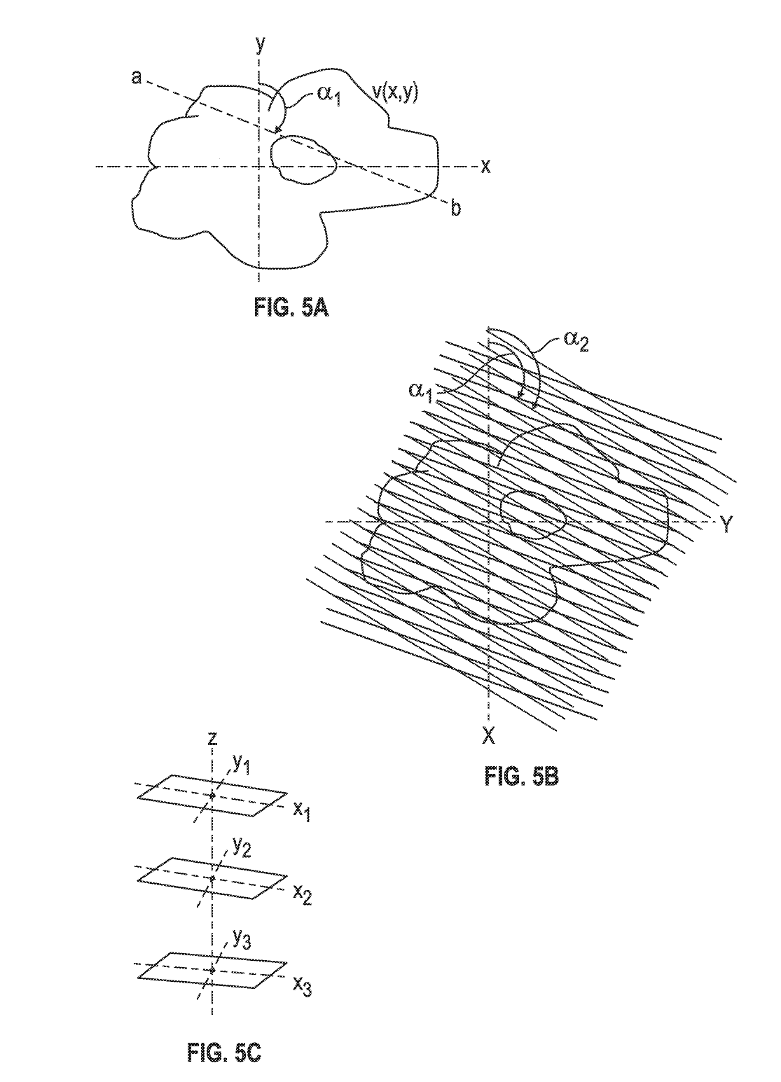

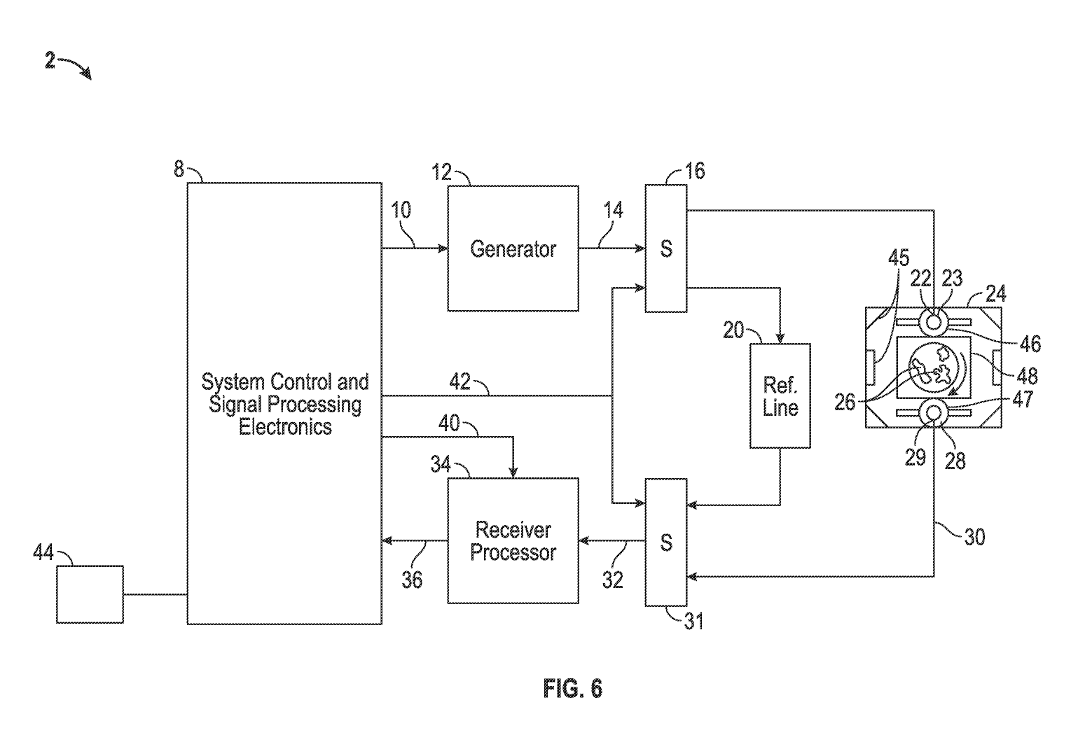

FIG. 5A is a representation of a single UWB pulse passing through a material from location A to location B in an X-Y orthogonal plane. FIG. 5B is a representation of a series of pulses passing through the material in stepped parallel line protections in an X-Y plane. FIG. 5C is a representation of a series of pulses passing through the material in stepped parallel line protections in an X-Y-Z space. Further, the pulse can be varied depending on the material or even different types of pulses for the same material, so that an optimized bandwidth(s) is presented to the material. As described above, a pulse passing through a material can be dispersed and the dispersion can be used to characterize the material and its properties. Additionally, a series of pulses passing through the material at different locations on the material can be used to characterize larger portions or all of the material. In at least one embodiment, a series of pulses can pass through the material at different parallel paths in incremental fashion to generate a 1-D characterization of the material at the incremental paths.

A significant advantage can be gained by generating a series of pulses at different parallel paths in incremental fashion at different angles relative to each other to generate a 2-D characterization of the material at the incremental paths. The different angles form a grid of locations having values of v at a particular X-Y coordinate, herein v(x,y). A mapping or image of the collection of values at the respective coordinates v(x,y) can be generated to reveal characteristics of the material.

Further, a 3-D characterization can be generated by following similar principles but at different depths along a Z-axis. A series of pulses can be generated at different angles in a given plane, and incrementally relocated at a different depth and repeated for a data set at a different depth of the v(x,y) values to generate a set of values v(x, y, z).

While the above paths are described in reference to orthogonal coordinates, it is understood that a rotational coordinate system could be used. Further, the material could be rotated relative to a placement of a transmitter-receiver orientation, the material could be rotated and moved laterally while the transmitter and receiver remain in fixed position, the material could remain stationary, which the transmitter and receiver move laterally for multiple paths through the material, the transmitter and receiver could move radially around the material for multiple paths while the material remained stationary or rotated, the transmitter could move at different lateral locations relative to the receiver to obtain angular paths at different distances from the receiver, and other variations.

For further details, to illustrate the transit time image formation process, consider the one dimensional equivalent, wherein the speed of an electromagnetic wave in 1-D at a positional dependent velocity is u(x). Then

$$\frac{d x}{d t} = u ( x ) or d t = \frac{d x}{u ( x )} \qquad ( 1 )$$

In a nonmagnetic medium having a complex electrical permittivity that accounts for both energy storage and energy dissipation effects, the speed of propagation is

$$u = \frac{1}{\sqrt{{μ}_{0} {ɛ}_{0} ( \frac{{ɛ}_{r}^{′} + \sqrt{{ɛ}_{r}^{′2} + {ɛ}_{r}^{″2}}}{2} )}}$$

where ∈′ᵣ is the real part of the complex relative permittivity and ∈″ᵣ is the imaginary part.
For our purposes we can describe the velocity in terms of a two-dimensional effective dielectric constant, ∈(x,y), wherein we have combined effects of the energy storage and energy effects into a single parameter.

$$u = \frac{1}{\sqrt{{μ}_{0} ɛ ( x , y )}}$$

Substituting into (1),

dt=\sqrt{μ₀∈(x,y)}dx

Thus, as shown in FIG. 5A, the time for a ray to propagate from a to b is the line integral

$${t}_{a -> b} = \sqrt{{μ}_{0}} {\int }_{a}^{b} \sqrt{ɛ ( x , y )} d 𝓁$$

### Equivalently,

$${t}_{a -> b} = \frac{1}{c} {\int }_{a}^{b} n ( x , y ) d 𝓁$$

where n(x,y) is the effective index of refraction of the object and

$$c = \frac{1}{\sqrt{{μ}_{0} {ɛ}_{0}}}$$

is the speed of light in a vacuum. This line integral can serve as a point tomographic projection for the refractive index. The inversion problem, then, is to calculate the refractive index profile given these projections at all angles through the object. Consider the case illustrated in FIG. 5B, where a large number of such line projections were taken such that all lines are parallel and closely spaced. The sequence of point projections is then equivalent to samples of the delay of a planar wavefront passing through the object. Such planar projections passing through the object at all angles constitutes the Radon transform. Transform inversion to the refractive index profile then can be reconstructed using filtered backprojection.

The imaging operation for the dispersion of the propagating signal follows a similar development where the projections are produced by considering the effects of nonlinear phase response cause by the frequency dependent properties of the complex permittivity. The nonlinear phase response also acts to lengthen the time duration of a very narrow time-domain pulse or conversely lengthen the equivalent time duration of the inverse Fourier transform of a wideband spectral-domain signal that can be produced by sweeping or stepping the frequency of a continuous wave (CW) signal either in a linear fashion or according to a pseudorandom sequence over a longer period of time.

### Embodiment of Technology

FIG. 6 is a block diagram of an exemplary embodiment of a sensor system. The sensor system 2 includes various components for controlling, generating, receiving, and processing signals that are dispersed in accordance with the teachings herein. As an exemplary embodiment, a system controller/processor 8 is coupled to a signal generator 12. The controller/processor 8 can control the generator 12 to generate EM energy signals to the system. The generator 12 produces a generator output 14 for testing the material in question. The EM energy signals can be pulsed signals, such as short duration pulsed signals having an ultra-wide bandwidth such as shown in FIG. 2, described below. Alternatively, the EM energy signals can be stepped signals that sequentially expose the material being analyzed to each frequency of interest through a sweep mode. The EM energy can have a wide bandwidth, such as created by amplitude, phase, or frequency modulation, or a combination thereof. Elements which support evanescent waves having a wide bandwidth characteristic are also contemplated and can be included with a sensor and its related assembly. In at least one embodiment, the generator 12 can generate a repetitive sequence of UWB pulses, discussed herein.

A switch 16 is coupled to the generator 12, and a transmitter 23 is coupled to the switch 16 through a transmitter input port 22. To help reduce reflected and scattered transmission paths, a linear polarized transmitter can be used. If measuring a horizontal plane representing an X-Y axis, the linear transmitter can be oriented vertically. If measuring in the vertical Z-axis, the linear transmitter can be oriented horizontally. The function of switch 16 can alternatively be accomplished by a power divider circuit and is included as an effective equivalent. The generator output 14 thus is able to be communicated through the switch 16 to the transmitter 23. The transmitter 23 transmits the EM energy signals to an object 26 (or objects). The object 26 can be any material and is generally capable of allowing EM energy to pass therethrough.

A receiver 28 receives the transmitter EM energy from the transmitter 23 to produce response signals through a receiver output port 29 to the receiver output line 30. Like the transmitter, the receiver 28 can be a linear polarized receiver. In other embodiments, the transmitter and/or receiver can allow for polarization diversity. If the generator produces pulses, then the signals at the receiver 28 will be dispersed pulses such as shown in FIG. 4, described above. A printed circuit antenna, as a receiver of either patch or slot configurations, can be suitable for reception, and/or as a transmitter for transmission. In addition the transmitter and/or receiver can be optimized to consider other forms of energy input into the container for other purposes, such as heating the material.

As explained in reference to FIGS. 5A-5C above, a transmitter driver 46 can move the transmitter 23 to different locations relative to the placement of the object 26 for different paths of transmission through the material. For example and without limitation, the transmitter driver 46 can be a stepper motor or other device for moving the transmitter in a space. Similarly, a receiver driver 47 can move the receiver 28 to different locations relative to the placement of the object 26 for different paths of reception through the material. Generally, the locations of the transmitter 23 and receiver 28 will remain in synchronization with each other so that the relative placement between the transmitter and receiver remains constant, although in some embodiments the movements can be varied to effect different angles and paths of transmission and reception. A rotation assembly 48 can turn the object 26 to different angles relative to the transmitter, also as described in FIGS. 5A-5C.

A switch 31 is coupled to the receiver output port 29, and a receiver processor 34 is coupled to the switch 31. The function of switch 31 can alternatively be accomplished by a power combiner circuit and is included as an effective equivalent. The receiver processor 34 is coupled to the system controller/processor 8, referenced above. The signals at the receiver output port 29 are communicated through the receiver output line 30 to the switch 31 and then to the receiver processor 34. If the receiver processor 34 uses equivalent time sampling methodology, then the receiver processor 34 can sample the sensor output having the response signal to produce an acquired sample representation.

The functions performed by controller/processor 8 also comprise system-timing operations, including initiation control signals 10 to the generator 12, generating switch control signals 42 for control of switches 16 and 31, receiver sampling control 40 for control of sample timing in receiver processor 34, as well as synchronization and interactive system and visual display control.

In at least one embodiment, the signals at the sensor output 30 received by the receiver processor 34 can be time-sampled to convert the output to a digital format that can be used by the controller/processor 8. If short UWB pulses are used, then an accurate digital representation of a narrow-width pulse ordinarily would require that the pulse be sampled at a very high sampling rate, which requires relatively costly electronics. This high cost can be avoided using a technique known as equivalent time sampling (also known as extended time sampling). Rather than sample each pulse at a very high rate, each sample that is needed to provide an accurate representation of a pulse can be acquired from a different pulse in the sequence of pulses received from receiver 28. This type of sampling allows use of a much slower sampling rate, because of the relatively long time duration between pulses. The samples obtained from each pulse are then temporally aggregated to form an acquired sample representation that accurately reproduces a dispersed pulse. This sampling method substantially reduces the cost of the receiver and enables the advantageous use of UWB pulses for material measurements that would otherwise be prohibitively expensive in many applications.

Generally, the object 26 will be at least partially contained in a container 24. The container 24 can include EM energy wave guiding surfaces 45 in the corners, on side walls, on the top and bottom, and/or other locations to assist in amplifying and/or guiding the EM energy from the transmitter to the receiver. The wave guiding surfaces 45 can include metamaterials, lenses, reflectors, or other wave guiding surfaces or shapes. The effects of reflection and multi-path propagation can be reduced, guided, or utilized to enhance and/or amplify the signal generated by the pulse for the receiver. In some embodiments, the measurements may intentionally measure a reflected signal that has traversed the material being tested more than once, such as twice or more times. The container can serve as a waveguide for the EM pulses.

Because the EM energy signals can propagate outside the container 24, unwanted reflections of propagating energy from obstructions exterior to the container can occur. However, because of the time delay that occurs for propagating energy to exit the dispersive medium, reflect from an obstruction, and return to the sensor, this unwanted reflected energy will arrive at a time that is discernibly later than the time of arrival of the energy that is communicated directly through the dispersive medium. The receiver processor 34 can discriminate between the late-arriving energy and the energy communicated directly through the dispersive medium. By excluding the late arriving energy from the process, measurement errors arising from unwanted reflections are avoided.

To accurately measure time of arrival and the dispersion caused by the material, as well as to distinguish the dispersed pulse from unwanted later-arriving energy, the UWB pulses of at least one embodiment are generally of very short duration, preferably exhibiting a very rapid rise time, and the time duration between successive pulses must be sufficiently long in comparison to the duration of a pulse. In at least one embodiment, the duration of a pulse can be on the order of a nano-second or fractions of a nano-second, such as picoseconds (such as 100 picoseconds and others), and the pulse repetition frequency is on the order of a few mega-Hertz (MHz).

Further, the system can provide for time-domain gating in receiving and processing the signals. The process of time-gating excludes energy in the received signal that occurs before or after a designated time. This gating can reduce or eliminate sources of error arising from the upstream and downstream reflections of energy from obstructions exterior to the dispersive medium. For example, when the generator 12 produces a repeating sequence of pulses, the time-gate is applied repetitively to exclude unwanted energy arising from each pulse in the sensor output, while accepting the desired energy arising from each pulse. Time gating can also be used to separate the reference line signal from the sensor output signal. The reference line path can be shorter than the measurement path to permit time separation of the measurement and reference signals.

For those embodiments using pulses for input EM energy, the timing of the pulses can be at a regular spacing according to a fixed pulse repetition frequency. Thus, the time intervals between successive pulses will be substantially equal. Alternatively, a pseudo-random or other non-uniform pulse spacing technique can be used. A non-uniform spacing can be selected that will distribute the various frequency components in the pulse sequence over a broad band of frequencies that will appear as a low level noise spectrum to other electronic equipment that could otherwise be affected by stray emissions from the sensor electronics.

The acquired sample representations may be displayed on an output device 44, such as a video monitor, and visually observed to obtain information concerning properties of the substance. For example, the output device 44 may show the image as a function of the properties being tested on the material, various digital and analog information relative to the material properties, and may show the amplitude and shape of the received output as a function of time. An image can be generated by using inverse Radon transform processing software or other algorithms. A time lag between the time when an input energy is transmitted and the time when the output energy is received is caused by the time duration of propagation of the input energy interacting with the material. This time delay can be visually observed and employed to infer properties of the substance. Further, the material interacting with the input energy may cause an attenuation of energy amplitude that can also be visually observed. Moreover, the substance interacting with the energy may cause dispersion of the energy, thereby causing a visibly observable distortion of the shape of the output energy.

Further, specific output signals can be visually displayed and analyzed in either the time domain or frequency domain. As is known, a signal that varies as a function of time may be represented by a unique signal that varies as a function of frequency. Either representation contains equivalent information. They are mathematically related by a Fourier Transform integral. This integral resolves a continuous-time signal into a continuous-frequency spectrum. Thus, in the alternative to time-domain analysis, it may be convenient to convert the output equivalent-time sampled pulse signal to the frequency domain. The acquired sample representation may be converted to a frequency-domain representation using a Fast Fourier Transform (FFT) algorithm prior to further analysis. The FFT resolves the acquired sample representation into a discrete frequency spectrum.

Further, although applying a Fourier Transform to the output signal enables display and analysis in the frequency domain, other transformations may be applied to the signal captured by receiver processor 34 to cause other attributes of the signal to be exhibited and analyzed. For example, certain frequency components may be weighted more heavily due to a priori knowledge concerning a desired frequency response of the substance. Likewise, the acquired signal may be time-weighted to emphasize certain temporal features of the signal. As another example, the acquired signal, after being transformed to the frequency domain may be processed by digital filtering before further analysis. Also, the signal can simply be integrated or differentiated prior to or after one or more other transformations are applied. Thus, more generally, the response signal may be processed by performing a transformation of the response signal to produce a resultant signal that is a function of a variable of the transformation.

The aforementioned signal processing of the acquired sample representation obtained in receiver processor 34 can be performed by the controller/processor 8. Further the controller/processor 8 can use decision algorithms to predict values for the parameter variables of interest. As will be understood controller/processor 8 may include a microprocessor operating under the directions of software that implements the desired algorithms and other functions.

It will often be useful to normalize the spectrum of the signals from the receiver 28 30 by the spectrum of the input signals from the generator output 14. The normalization process has the benefit of removing unit-to-unit variations in both the amplitude of the transmitted signals and the gain and frequency response characteristics of the receiver processor 34. To accomplish the normalization, an attenuated sample of the input signal may be applied directly to the input of the receiver processor 34 through reference line 20. An input to the reference line 20 can be communicated through the switch 16 that is coupled to the reference line. An output from the reference line 20 can be communicated through the switch 31 that is coupled to the reference line. The receiver processor 34 and/or system controller/processor 8 can then reproduce an input signal to the transmitter 23 and convert the input signal and sensor output to common units for normalization. In at least one embodiment, the input and output of the transmitter and receiver, respectively, can be converted from a time domain representation to a frequency domain representation through a Fourier Transform, such as an FFT, to produce a spectral representation of that input signal to the sensor and the output signal from the sensor. When the signals are converted to decibels (dB), normalization involves simple subtraction operations between the input signal and the output signal.

As another example of the output device 44, the device can be coupled with a portable sensor that can be activated to initiate a measurement of one or more desired conditions. An indicator on the device can indicate whether sufficient data is gathered to provide a measurement of the intended condition(s) or whether another attempt is required. Based on an analysis conducted on sufficient data, such as described above, a display on the device can indicate one or more conditions that are being measured, such an analog or digital readout of a numerical value, a sequence of various lights, various colored-coded lights, or other visual indicators of the one or more conditions. In addition to or substitution of one or more visual outputs, in some embodiments, the output device 44 may provide other output, such as audible, tactile, or other sensory output. The output device may include capabilities for transmission, such as Bluetooth® technology, infrared, and other wireless or wired transmission means. The output device 44 can be an alarm indication consisting of a blinking light, a buzzer or similar indication to communicate to a user that a predetermined condition of the material under test has been reached or exceeded, requiring some response on the part of the user. The transmission can be coupled with a computer, monitoring system, pager, or other devices that, for example, can alert third parties of an adverse or other sensed condition, especially if the user is unable to seek help or otherwise respond or communicate.

An exemplary embodiment of the container 24 and associated equipment such as the transmitter 23 and receiver 28 merely for illustrative purposes and without limitation follows. An aluminum table can function as a rotation assembly 48 and can be used to support the object during scans of its material as described in reference to FIGS. 5A-5C. Transmitter and receiver bi-conic antennas can mounted to the table on a single bracket, which moves back and forth on a Velmex Bislide 3MN10, controlled by a stepper motor. A Vexta CFK II 5-phase stepper motor can rotate the object platform.

To generate the line projections shown in FIG. 5B, an object can placed on the table. The bi-conic antennas can be linearly translated by small increments and a line projection be taken at each increment. When the cones reach the end of the translation, the table can be rotated by a small angle and the process repeated. For example and without limitation, the total translation can be approximately 20 cm and the increment can be 0.04 cm per step for a total of 500 projections per angle of measurement through the object. The angular increments can be equally spaced and the table can be rotated 180 degrees. If 250 angular increments are used, then the incremental angles are 0.72 degrees. Therefore, 125,000 line projections (250 angles multiplied by 500 lines per angle) can be generated for each image.

The imaging signals can be generated and processed by an HP 8722 ET vector network analyzer. The frequency span can be from 1 to 20 GHz and the time domain option can be used to convert the frequency scans to a time domain representation using the systems internal Fourier transform processor.

Control for the data collection and platform/antenna motion can be provided by a Visual Basic program running on a laptop. This program has two functions: to control the acquisition of microwave data from the antennas and to control movement of the antennas/table in the appropriate manner after data has been collected. An RS-232 interface can control a Basic Stamp 2E microcontroller mounted on BS2E Board of Education development board for access to pins and power. This microcontroller can be responsible for sending the appropriate pulses to the Velmex Bislide and the Vexta rotational motor.

The antennas can be mounted 25 cm above the surface of the table and the rotational assembly. The table can require use of an electromagnetically invisible object booster to position the objects in the center line of the antennas. Such placement can reduce reflections that corrupt the received signal.

Other and further embodiments utilizing one or more aspects of the inventions described above can be devised without departing from the spirit of Applicant's invention. Various types, sizes, and amount of components can be used to achieve a desired response. Various types of EM energy, including electric fields created by applying discrete frequencies or pulses having wide band of frequencies, can be applied to the object(s) with the material(s) to be measured. Electrical permittivity, magnetic permeability, or a combination thereof can be used to determine the characteristics to be measured. Other variations are possible.

Further, the various methods and embodiments of the sensor system and methods herein can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled, “coupling, “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalent of the following claims.

What is claimed is:

1. The method of forming an image of the interior of an object or collection of objects based upon a transit time and dispersion of wideband signals that are caused to propagate through an object or collection of objects possessing electromagnetic properties.

2. The method of claim 1, wherein the object or objects comprise a non-homogeneous distribution of materials having distinct complex electromagnetic properties.

3. The method of claim 1, wherein the signals are applied and received having polarization diversity.

4. The method of claim 1, 2, or 3, wherein the signal dispersion and an associated measurement are augmented by a suitable arrangement of slow wave structures or backward wave structures using metamaterials, lenses, reflectors, or other wave guiding surfaces or shapes.

5. The method of claim 4, further comprising forming an image as in claim 3 where the wave guiding shape is a corner reflector.

6. The method of claim 5, wherein the signal is caused to make more than one transit through the object or collection of objects to increase the delay and dispersion of the wideband signal.

7. The method of claims 1-6, further comprising collecting data from the signals or a subset of said data and computing an average complex permittivity value for the object or collection of objects.

8. The method of claims 1-7, further comprising computing the calorie content of one or more food portions based upon the images generated or data collected according to claims 1-6.

9. The method of claims 1-8, wherein a signal source for the signals produce a sequence of narrow pulses of energy which are processed according to an extended time sampling process.

10. The method of claims 1-8, wherein a signal source for the signals produce produces a pseudorandom sequence of wideband pulses of energy.

11. The method of claims 1-8, wherein a signal source for the signals produces a wideband linear frequency sweep of electromagnetic energy.

12. A method of non-destructive measurement of objects as substantially shown and described herein.

13. A system for non-destructive measurement of objects as substantially shown and described herein
